(19) United States
(12) Patent Application Publication
(10) Pub. No.: US 2026/0278078 A1
(43) Pub. Date: Sep. 17, 2026

(54) INSTRUSION DETECTION SYSTEM USING SIDE CHANNEL MEASUREMENTS

(71) Applicant: Robert Bosch GmbH, Stuttgart (DE)

(72) Inventors: Stefan GEHRER, Pittsburgh, PA (US); Jorge GUAJARDO MERCHAN, Pittsburgh, PA (US); Sekar KULANDAIVEL, Pittsburgh, PA (US); Pradeep M. PAPPACHAN, Pittsburgh, PA (US); Shalabh JAIN, Pittsburgh, PA (US)

(21) Appl. No.: 19/079,533

(22) Filed: Mar. 14, 2025

(51) Int. Cl. G06F 21/55; G06F 21/56; H03M 1/12

(52) U.S. Cl. CPC G06F 21/554; G06F 21/566; H03M 1/12; G06F 2221/034

(57) ABSTRACT

An apparatus for detecting intrusions into a computer system is disclosed. An intrusion detection system includes a first power interface configured to receive power from an external power source and a second power interface configured to provide the power to a computer system. A power bus conveys power from the first power interface to the second power interface. A sensor circuit is configured to detect power signals indicative of variations in the power, while an analog-to-digital converter (ADC) circuit configured to, using the power signals, generate a plurality of digital signals. A storage circuit is configured to store a detection program and a machine learning model. A processor is configured to, using the plurality of digital signals, execute the detection program and the machine learning model, and, in response to detecting an attack on the computer system, perform one or more corrective actions to protect the computer system.

### TECHNICAL FIELD

The present disclosure relates to computer systems, and more particularly, to the detection and prevention of malware intrusions on a computer system.

### BACKGROUND

Maintaining computer and network security is a complex task. Computer systems and networks are often subject to attempted intrusions to, e.g., steal data, as well as to implant malware (e.g., ransomware) thereon. Attackers have, in recent years, resorted to more and more sophisticated techniques for carrying out attacks on computer systems and networks thereof. While many types of software exist to counter these attacks, there is a race for such software to keep up with the evolving tactics of would-be attackers.

### SUMMARY

An apparatus for detecting intrusions into a computer system is disclosed. In one embodiment, an intrusion detection system includes a first power interface configured to receive power from an external power source and a second power interface configured to provide the power to a computer system. A power bus in the intrusion detection device is configured to convey power from the first power interface to the second power interface. A sensor circuit is configured to detect power signals indicative of variations in the power, while an analog-to-digital converter (ADC) circuit is configured to, using the power signals, generate a plurality of digital signals, which are streamed therefrom to a processor of the intrusion detection system. A storage circuit of the intrusion detection system is configured to store a detection program and a machine learning model. The processor of the intrusion detection system is configured to, using the plurality of digital signals, execute the detection program and the machine learning model, and, in response to detecting an attack on the computer system, perform one or more corrective actions to protect the computer system.

### BRIEF DESCRIPTION OF THE DRAWINGS

FIG. 1 illustrates a block diagram of an exemplary computing device, according to some embodiments of the disclosure.

FIG. 2 illustrates an arrangement of a computer system and an intrusion detection system coupled thereto in accordance with an embodiment of the disclosure.

FIG. 3 illustrates a block diagram of one embodiment of an intrusion detection system.

FIG. 4A illustrates one embodiment of a sensor used in an intrusion detection system in accordance with the disclosure.

FIG. 4B illustrates another embodiment of a sensor used in an intrusion detection system in accordance with the disclosure.

FIG. 5 is a flow diagram illustrating one embodiment for operating an intrusion detection system in accordance with the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations. “A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The prevention of attacks and intrusions on computer systems typically utilizes various types of software. Computer and network security software may detect attacks such as viruses, ransomware attacks, and other types of attacks to access data without authorization. Accordingly, various types of software, such as anti-virus software, firewalls, and other types of security suites have been developed to combat malicious actors who would compromise computer/network security.

The present disclosure makes use of the insight that attacks and attempted intrusions on a computer system have distinct electrical characteristics due to the particular processor workloads. These electrical characteristics are reflected in variations in the current or power drawn by the computer system as a result of, e.g., switching due to various operations carried out in the system. Accordingly, the present disclosure is directed to an intrusion detection system that utilizes measurements of the power as a basis for detecting intrusions and attacks. The intrusion detection system may be implemented external to the computer system, in a path between an external power source and the computer system itself. The intrusion detection system includes a sensor configured to generate analog signals based on sensing variations in the power as provided to the computer system and convert these analog signals into digital signals. The digital signals are then provided to a processor (e.g., in a continuous streaming format) that executes a detection program and machine learning model. In response to detecting an intrusion/attack, the intrusion detection system may perform one or more corrective actions to protect the computer system. These actions may include disconnecting power and/or disconnecting the computer system from a network, among others. Additional details are discussed below.

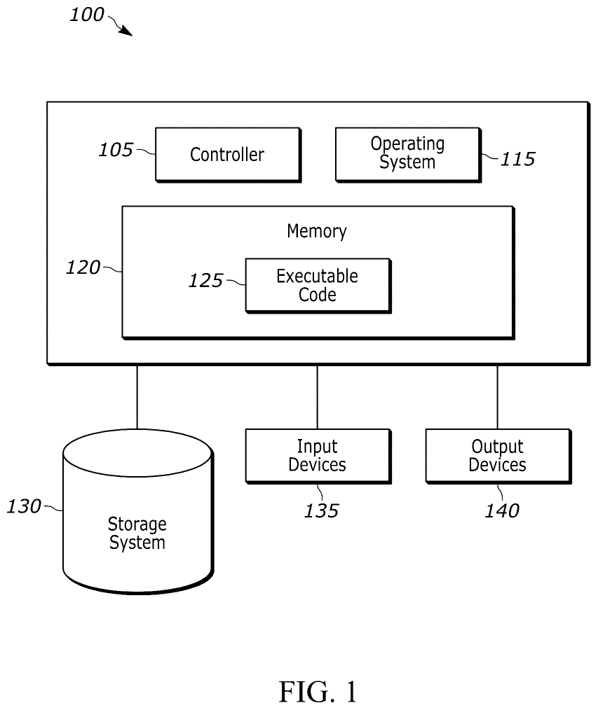

FIG. 1 illustrates a block diagram of an exemplary computing device, according to some embodiments of the disclosure. Device 100 as shown may be comprised within an intrusion detection system as discussed herein, as well as a general purpose computing device. The device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the disclosure.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that enforces security in a vehicle as further described herein, for example, detects or prevents cyber-attacks on in-vehicle networks. Although, for the sake of clarity, a single item of executable code 125 is shown in FIG. 1, a system according to some embodiments of the disclosure may include a plurality of executable code segments similar to executable code 125 that may be loaded into memory 120 and cause controller 105 to carry out methods described herein. Where applicable, the terms “process” and “executable code” may mean the same thing and may be used interchangeably herein. For example, verification, validation and/or authentication of a process may mean verification, validation and/or authentication of executable code.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, various ones of the components shown in FIG. 1 may be omitted. For example, memory 120 may be a nonvolatile memory having the storage capacity of storage system 130. Accordingly, although shown as a separate component, storage system 130 may be embedded or included in memory 120.

Input devices 135 may be or may include any suitable input devices, components or systems, e.g., physical sensors such as accelerometers, tachometers, thermometers, microphones, analog to digital converters, etc., a detachable keyboard or keypad, a mouse and the like. Output devices 140 may include one or more (possibly detachable) displays or monitors, motors, servo motors, speakers and/or any other suitable output devices. Any applicable input/output (I/O) devices may be connected to computing device 100 as shown by blocks 135 and 140. For example, a wired or wireless network interface card (NIC), a universal serial bus (USB) device, JTAG interface, or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate, with control or other units in a vehicle, e.g., input and/or output devices or components 135 and 140 may include ports that enable device 100 to communicate with an engine control unit, a suspension control unit, a traction control and the like.

Embodiments may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as computing device 100.

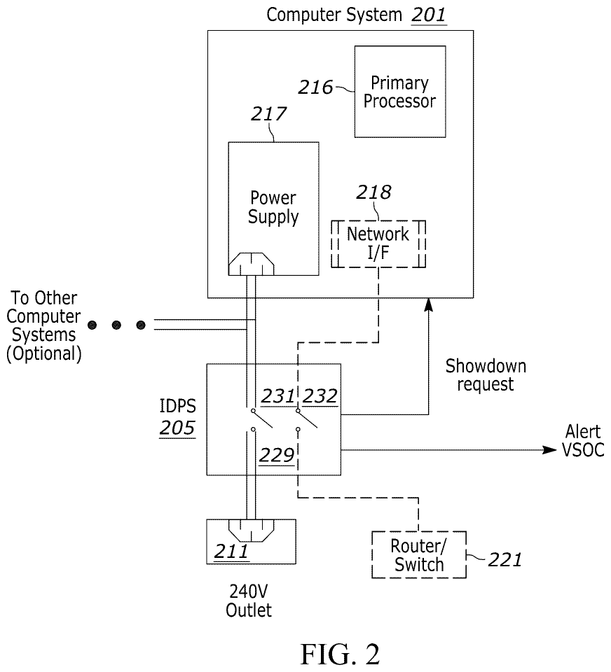

FIG. 2 illustrates an arrangement of a computer system and an intrusion detection system coupled thereto in accordance with an embodiment of the disclosure. In the embodiment shown, intrusion detection and prevention system (IDPS) 205 is coupled between an external power source 211 (a 240 V outlet in this non-limiting example) and a power supply 217 of computer system 201. Power supply 217 may include any suitable power supply circuitry, including AC-DC and DC-DC converter circuits. IDPS 205 includes a power bus 229 which conveys power from the external power source 211 to power supply 217 when power switch 231 is closed. IDPS 205 may also include a network switch 232 coupled between a network interface 218 of computer system 201, and a router/switch 221 through which a connection to a network may be made. Network switch 232 may be any type of switch (hardware, software, or combination thereof) capable of connecting and disconnecting computer system 201 from router/switch 221.

Computer system 201 as shown here includes a primary processor 216 which carried out the various data processing functions of the system. Primary processor 216 may be one of a number of different processor types, including single-core processors, multi-core processors, and so on. Although not explicitly shown here, computer system 201 may include other functional units, including storage units, various input/output (I/O) units, graphics processors, various types of memory circuits and subsystems (including both volatile and non-volatile), and the previously mentioned network interface 218.

IDPS 205 in the embodiment shown may, using measurements of the power provided to computer system 201 (and variations therein), determine whether computer system is under attack by malware (e.g., ransomware, spyware, etc.) or other type of attack. Upon detecting an attack or the presence of malware on computer system 201, IDPS 205 may take actions such as removing power therefrom (by opening power switch 231, cutting off network access by opening network switch 232 to disconnect computer system 201 from router/switch 221), generate an alert to a virtual operations security center (VSOC) or other security center, and so on. A combination of these actions may be taken as well. Prior to removing power from computer system 201, IDPS 205 may assert a shutdown request to cause actions to be taken such as backing up modified files, saving a processor state, and so on.

While IDPS 205 is shown coupled to only a single computer system 201 in the example shown, it is noted that a single instance of IDPS 205 may be coupled to and may protect multiple computer systems.

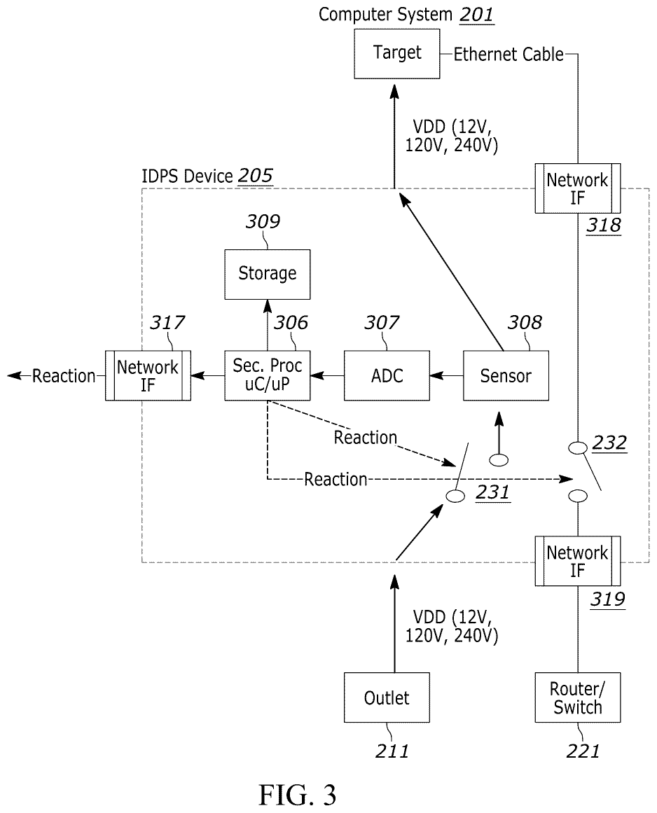

FIG. 3 illustrates a block diagram of one embodiment of an intrusion detection system. In the embodiment shown, IDPS 205 includes a sensor 308, an analog-to-digital converter (ADC) circuit 307 (which may include, or be augmented by, other circuits such as operational amplifiers, transistors, resistors, capacitors, inductors, and so on), a processor 306, a storage circuit 309, and network interfaces 317, 318, and 319. Power may be received by IDPS 205 from an external power source 211 (an outlet in this non-limiting example) and conveyed to a computer system 201.

Sensor 308 in the embodiment shown is in the power path coupled between external power source 211 and computer system 201. Using sensor 308, variations in the power provided to computer system 201 may be measures. Sensor 308 may be implemented in various ways. For example, in one embodiment, sensor 308 may be implemented as shunt resistor (and more generally, an impedance) in line with the power bus, for AC and/or DC measurements. Electromagnetic sensors are also possible and contemplated, with variations in a magnetic field converted into a voltage. Other possible sensor implementations include a transformer-based current clamp for AC measurements, a hall-sensor based current clamp for AC and DC measurements, temperature-based measurements (temperature distribution of the CPU and/or overall processor(s) while processing; temperature of resistor/impedance in line with power supply, ambient temperature of machine e.g. at fans), vibration measurements, and/or sound measurements. Another possible implementation of a sensor circuit includes a Rogowski coil (which comprises an air core toroidal coil), a fluxgate magnetometer, various types of DC current measurement circuits (when the power passing through is DC power), and so on. In general, any type of sensor apparatus capable of sensing variations in the power passing through IDPS 205 is possible and contemplated. Embodiments including a combination of different sensor types are also possible and contemplated.

ADC 307 in the embodiment shown may be of any suitable type. Although not shown here, ADC 307 may receive a clock signal to synchronize the sampling operations. The frequency of sampling may be such that variations in power can be captured commensurate with the frequency at which the main processor of the computer system operates when executing program instructions. ADC 307 may generate digital signals using the analog signals (corresponding to power variations) from sensor 308, streaming the digital signals to processor 306 as each sample is taken. Additional circuitry may be included within, or with ADC 308. Such circuitry may include operational amplifiers, individual transistors, resistors, capacitors, inductors, and other circuit elements. In some embodiments, filter circuits may be included to, e.g., filter out unwanted frequency components prior to converting the analog signals to digital.

Storage circuit 309 in the embodiment shown may be any suitable storage/memory mechanism for storing code and data used by processor 306 during operation of IDPS 205. In various embodiments, storage circuit 309 may comprise a non-volatile memory such as a flash memory or any other suitable type of medium for providing persistent storage. Storage circuit 309 may store information such as the pre-trained machine learning/deep learning classifier models, which may be updated during operation based on detections of intrusions and malware by various instances of IDPS 205. These models may be used for detecting one or more of a number of different types of malware, such as ransomware, spyware, worms, viruses, adware, rootkits, trojans, botnets, fileless malware, among other non-limiting examples. The detection software itself may also be stored on storage circuit 309, and this software may also be updated over time, effectively giving IDPS 205 the ability to reconfigure itself. In some embodiments, raw data (digital signals) may be stored in storage circuit 309 for use in further analysis. Similarly, pre-processed and/or compressed digital data may also be stored in storage circuit 309 for further analysis. Storage circuit 309 may also be used to store logs of timestamps, results of analysis, and corrective/preventative actions taken, including forced shutdown of computer system 201, graceful shutdown of computer system 201, alerts sent the VSOC, and so on. Cryptographic keys extracted from malware/ransomware may also be stored in storage circuit 309 to enable the subsequent recovery of files that were encrypted during the attack.

Processor 306 may be implemented in various forms, such as an off-the-shelf microprocessor, a microcontroller, a field-programmable gate array (FPGA), an application specific integrated circuit (ASIC) or any other suitable mechanism for implementing a processing circuit capable of carrying out the functions of IDPS 205. During operation, processor 306 may carry out the various processing functions, using the detection software and the machine learning model stored on storage circuit 309, to detect an intrusion to or the presence of malware on computer system 201. Using the digital signals received from ADC 307, the processing carried out by processor 306 may focus on detecting) encryption processes caused by ransomware and/or other malware and heavy I/O traffic (amount and patterns of traffic) caused by reading and writing files during the encryption thereof. These digital signals (which may be sent in streams, or in groups known as windows or traces) may be used by a processor 306 to be analyzed and make a prediction of whether computer system 201 is under attack or the subject of a potential intrusion. The prediction is done using the machine learning model (e.g., using deep learning, convolutional neural networks, transformer networks, simpler ML algorithms such as decision trees or gradient boosting, etc.).

In some embodiments, processor 306 may include or be augmented by additional hardware. Such additional hardware may include additional hardware accelerators for faster pre-processing (e.g. Fast Fourier Transform accelerators), machine learning/deep learning accelerators (e.g., neural accelerators such as tensor cores). In the case that the additional hardware is separate from processor 306, a dedicated ASIC or FPGA could be used for carrying out these functions.

The concept of operation thus includes measuring digital signals during known benign behavior of computer system 201. Optionally, groups of signals from malicious actors (e.g., intrusions or malware) may also be measured on a test computer system. The digital signals resulting from the measurements may be pre-processed to extract features and/or compress the amount of data to be analyzed (e.g., filtering the data to focus on frequencies of interest). The digital signals may be used to train a classifier, e.g., an unsupervised machine learning classifier using clustering methods, a supervised deep learning classifier using convolutional neural networks, or other suitable models. Measurements may be taken persistently during operation at small enough intervals to enable rapid detection, using the classifier to analyze the digital signals corresponding to the measurements. In various embodiments, the digital signals are provided to the processor in streams, although they may be provided in groups/windows in other embodiments.

Processor 306 may, depending on the results of analysis carried out thereon, take various corrective and/or preventative measures when malware/intrusions are detected. In case of a potential intrusion or malware detection, IDPS 205 may turn off (open) switch 231, which is in-line with the current supply to computer system 201, thereby immediately removing power therefrom. It is noted that IDPS 205 may operate using a power supply/source separate from that which provides power to computer system 201, and is thus not affected by such a shutdown.

Similarly, the network connection to the VSOC as shown here may be independent of the network connection used by computer system 201 to router/switch 221. Accordingly, as another response mechanism, IDPS 205 may, open switch 232 to disconnect computer system 201 from the remainder of its corresponding network while also sending a VSOC alert via a separate network connection coupled network interface 317. Thus, the network upon which the VSOC alert is conveyed may be both separate and isolated from the network that comprises router/switch 221.

In addition to the direct cut-off of power to computer system 201, IDPS 205 may also send a shutdown request. The shutdown request may allow computer system 201 to copy or duplicate and save certain files, such as those that were modified (e.g., encrypted) during and as a result of the attack, save one or more processor states that occurred during the attack, and so on. After completing these operations, computer system 201 may then shut down.

Another possible corrective/preventative action that may be taken by various embodiments of IDPS 205 is to throttle the frequency of a processor within computer system 201. This may slow down the processing of the malware, and may thereby allow for a more positive identification of the particular type executing on computer system 201. Similarly, embodiments of IDPS 205 are possible and contemplated in which the voltage in the power path between external power source 211 and computer system 201, or one computer system 201 itself, may be throttled. This in turn may result in reduce performance of computer system 201, which may, e.g., slow down the encryption process of the malware operating thereon. As an alternate to direct throttling, IDPS 205 may include a mechanism to cause heating up of the primary processor of computer system 201 in order to force it into throttling its frequency. For example, IDPS 205 may cause computer system 201 to initiate additional compute-intensive workloads.

As noted above, VSOC alerts may be generated in response to detection of an intrusion or malware on computer system 201. The VSOC alert may allow a centralized, coordinated response to an attack by taking protective measures for other computers coupled to a same primary network as computer system 201. Such responses may include temporary network disconnection to allow isolation of the source of the attack, pushing updates to other instances of an IDPS 205 arranged to protect other computers, and so on. The ability to push updates to instances of IDPS 205 allows updates machine learning models and detection software to be stored and executed thereon, and thus allows reconfiguration of the device as threats evolve over time.

As noted above, storage circuit 309 may store various types of information related to an attack. Accordingly, in response to the detection of an intrusion or malware executing on computer system 201, processor 306 may cause certain details regarding the attack (e.g., timestamps, digital signal traces, result of classifier, etc.) to be stored on storage circuit 309. In some cases, the stored digital signal traces may be used to break encryption keys of detected ransomware/malware in the event that the keys were not previously extracted. Similarly, during operation, processor 306 may cause continual storage of digital signals (in a first-in, first-out manner) to enable capture of digital signal traces for some specified time prior to the attack. These signals may be used to break encryption keys utilized by malware/ransomware used during the attack.

Another possible corrective/preventative action involves IDPS 205 communicating with trusted system software on the computer system 201 for alerting and response to ransomware/malware activity. Once ransomware/malware activity is detected by the IDPS 205, it may communicate with trusted system software on the computer system 201 to alert it of the presence of the malicious software. For example, if the computer system 201 is running a hypervisor that cannot be easily attacked, IDPS 205 can communicate with the hypervisor over a secure communication channel using keys that are provisioned safely into both the computer system 201 and IDPS 205 itself. This communications channel can be used to alert the system software about ransomware activity. In response to this alert, the system software can take appropriate actions, such as suspending a process or Virtual Machine, shutting down the system gracefully, or restoring an old snapshot of the file system. The physical communication channel could be the wired network or wireless channels, such as WiFi or Bluetooth, depending on the bandwidth needed for communication. This channel could also be used to provide IDPS 205 with additional information about the current state of the target device that might help detecting ransomware. This information could be stored in the IDPS as additional metadata in case a ransomware is detected. Additionally, in embodiments in which IDPS 205 may communicate with trusted software running on computer system 201 over a network interface, the device may obtain signals therefrom to adapt its thresholds or parameters used in the algorithms for detection of ransomware/malware.

In addition to the examples shown in FIGS. 2 and 3, IDPS 205 may be implemented in other, alternative embodiments. One possible alternative embodiment is an in-cable IDPS, in which is a cable in which the IDPS device itself is integrated. Thus, instead of plugging the hardware IDPS in between the external power source and the computer system under protection, the IDPS itself is integrated into the power cable itself.

In another alternative embodiment, an IDPS may be implemented in an existing power supply. For example, an IDPS could be integrated into an internal power supply of a desktop PC (e.g., inside the PC), or integrated into an external power source thereof, e.g., a 120V->12V power supply brick of a laptop. If USB-C is used for charging, then the IDPS could be integrated into the USB charger and might be able to protect multiple devices if multiple devices are power from the USB charger.

A wall socket embodiment is also contemplated. In embodiments in which the external power source is a power outlet/socket integrated into the wall of a building, the IDPS may be integrated therein. Accordingly, the IDPS could provide protection to any computer having a power cord plugged into the wall socket.

Some embodiments of an IDPS may utilize edge processing provided by an external computing source. In various embodiments, the processing power implemented in an IDPS may not be sufficient to analyze the digital signal traces completely. In that case the measurements (in the form of digital signals) could be forwarded to a more powerful central computer for further analysis. Potential variants include an IDPS that carries out lightweight intrusion detection in the integrated hardware IDPS, and, if an attack is detected, measurements in the form of digital signals and other data may be forwarded to an edge computing system, which may perform further processing and respond to the attack. Such responses could include slowing down the computer system under attack instead of completely shutting it down, thereby allowing for further analysis of the threat prior to its removal. In embodiments where edge computing is employed, an IDPS may extract and compress some data to save bandwidth for transferring information to the edge computing system.

In some embodiments, an IDPS may inject signals into the electrical cable to alert, e.g., the power supply. A mechanism could be integrated into the power supply of the computer system under protection that recognizes this signal and turns itself off or react in other manners.

As noted above, some embodiments of an IDPS may be arranged to protect multiple computer systems. If the measurements are taken on a power cable that supplies multiple computer system, e.g., before a multi-outlet adapter, then the hardware IDPS could protect multiple machines at the same time. In case, the IDPS can be configured to detect ransomware/malware in each one of the machine or all of them as a group, and take action, either switching off of one them or all at once. Since ransomware/malware likely spreads from one device to another, detection on a few machines is indicative that the ransomware is likely on other ones. To distinguish between the various computer systems, the IDPS could inject unique patterns into the power profile of each machine (e.g., as the power supply or the processor) that would allow separation of the information obtained from each.

Various types of devices/computing systems may be protected by an IDPS in accordance with the disclosure. Such devices include servers (including rack mount servers), desktop computers with an internal power supply, laptop computer with an internal or an external power source, an industrial computers and machines. The disclosure further contemplates protection of automotive computers such as engine control units (ECUs). In the case of an ECU, instead of a shutdown in response to detection of an attack, the supply voltage can be dropped to 6V (about half of the typical supply). This drop triggers the limp-home mode on an ECU, which severely limits its functionality as a safety precaution. Likewise, a shutdown of a compromised ECU could trigger another ECU to take over functionality. A shutdown can be detected by the absence of status controller area network (CAN) messages from the

### Compromised Ecu.

In case a system with batteries, e.g., a laptop is used, a disconnection of the power supply may not immediately turn off a machine. Here a separate communication with a device that manages the laptop may be utilized (gracefully shutting down the laptop using a motherboard pin, or a management interface such as Intel ME). Alternatively, a direct connection to the power button of the laptop from the IDPS hardware device may be implemented in such a manner that when the IDPS device detects a ransomware attack it can actuate the power button of the laptop to force the laptop to turn off. This can be achieved, for example, by connecting the IDPS device pin to the power button connector in many types of computer system. The IDPS would send a corresponding signal to the power pins of the connector and which will allow to turn the machine off.

The disclosure further contemplates alternate hardware architectures. In one alternate architecture, which uses a generic processor, is one in which this hardware device is augmented with a Field Programmable Gate Array (FPGA). This may allow for the machine learning algorithms that perform the detection of the ransomware to be reconfigurable. Reconfiguration could be desirable in cases where the machine learning algorithm needs to learn over time, or the architecture of the machine learning model needs to be modified to add new features that would make it more efficient, faster, and/or consume less in memory resources. For example, a model can be chosen such that the model parameters are at first encoded as 16-bit floating point integers and then modified to only offer 4-bit precision but much larger number of model parameters. An FPGA can also offer protection of the machine learning model by allowing its configuration file to be encrypted with a key stored in the FPGA. This makes it harder for attackers to retrieve the architecture and model parameters, which are of high IP value. The proposed architecture can be implemented with only an FPGA or with an FPGA and a microcontroller or with the microcontroller possibly embedded in the fabric of the FPGA.

In some embodiments, an IDPS device may be attached to a running server using dual power supplies. Commonly dual active power supplies are used in servers, i.e., a server can lose one power supply without having to be shut down. This can be used to advantage by plugging two IDPS devices sequentially first into the line of a first power supply and then the line of a second power supply. In this manner, at least one of the power supplies will always be connected. The IDPS device could correlate and fuse the measurements from both power supplies to improve the accuracy of the model.

In various embodiments, tamper resistance measures can be deployed on the IDPS device to protect hardware and software against tampering and/or reverse engineering. This ensures enhanced security against unauthorized access. This may include active monitoring of physical integrity to detect any attempts at interference (“has the device been opened/tampered?”). In case of a breach, the system can respond with immediate protective measures, such as disabling access, triggering alerts, or erasing software/data.

In order to guarantee the integrity of the software running on the device, a root of trust can be used to enable mechanism such as secure boot and secure update of code and models. It is assumed that the code, models and data stored in the device may be stored in encrypted and authenticated form. During boot, the code would be decrypted and authenticated and loaded to start operation. If the decryption or authentication operation fail, a message can be sent to the VSOC to notify it of the failure. Locally, the failure can be shown by lighting one or more LEDs available in the device.

In some embodiments, an IDPS could monitor a network connection for the protected computer system and use the collected data as additional input for a detection mechanism of ransomware. As ransomware may be a) trying to spread in the network, and b) trying to encrypt network drives, monitoring such a connection can reveal valuable information. Metadata and/or content of the network messages could be provided to the processor of the IDPS for the purpose of sensor fusion with the side-channel measurements.

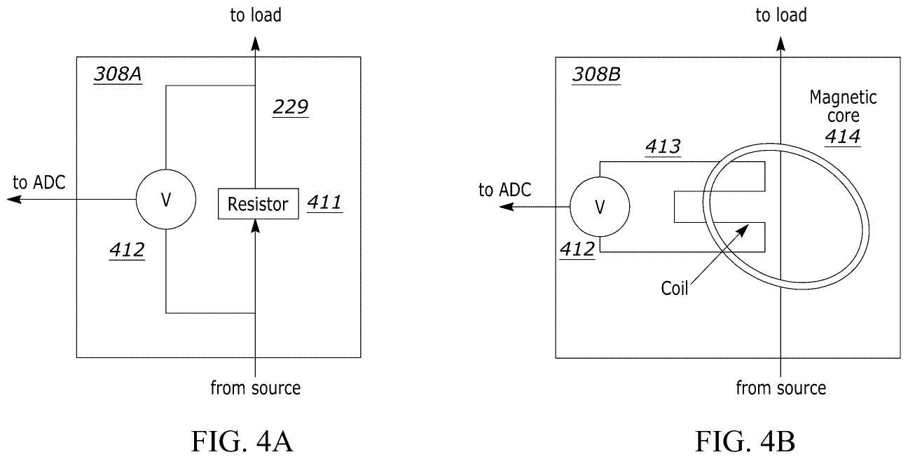

FIG. 4A illustrates one embodiment of a sensor used in an intrusion detection system in accordance with the disclosure. Sensor 308A of FIG. 4A includes a low resistance in-line shunt resistor (or impedance) 411 and a voltage measurement circuit 412. The resistance/impedance may be relatively low so as to not drop the voltage for the load by a significant amount. The voltage drop across the shunt resistor is proportional to the current by: I_{Shunt}=I_{DUT}=V_{Shunt}/R_{Shunt}. The voltage (and thus, variations thereof) can be measured by voltage measurement circuit and then sampled by the ADC. Alternatively, instead of fixed shunt resistor, an embodiment may have a programmable resistor (otherwise known as a potentiometer). This would have the advantage of allowing the IDPS integrated hardware to be adjustable to the signals that are trying to be captured for purposes of detection/recovery from a malware attack.

FIG. 4B illustrates another embodiment of a sensor used in an intrusion detection system in accordance with the disclosure. Sensor 308B of FIG. 4B may be implemented in the form of a current claim. A magnetic core may placed around a conductor to be measured. The measured conductor forms one (single loop) coil of a transformer. The other coil 413 with a known number of loops around the magnetic core 414 forms the other side of the transformer. The ratio of loops is proportional to the voltage/current measured on the other side of the coil. This transformer may then generate voltages based on the variations in the current flow through the conductor. These voltages can be measured by voltage measurement circuit 412 and further sampled by the ADC. This allows a non-intrusive non-contact measurement of the current in the wire.

As an alternate to the sensors of FIGS. 4A and 4B, an electromagnetic (EM) emanations sensor such as an electromagnetic probe or near-field probe may be implemented. Such a sensor is less intrusive than the transformer of FIG. 4B. By placing EM sensors close to computer system under protection, the sensor would be able to capture the fluctuations in the EM emanations from the computer system during its runtime, which can be used to fingerprint ransomware-like/malware-like processes. An EM sensor can be implemented using an antenna tuned to receive the EM radiation produced by the DUT during operation. As also noted above, other types of sensors, such as hall-effect-based sensors and Rogowski coil-based sensors are also possible, as well as any other type that can detect variations in the power passing through the sensor.

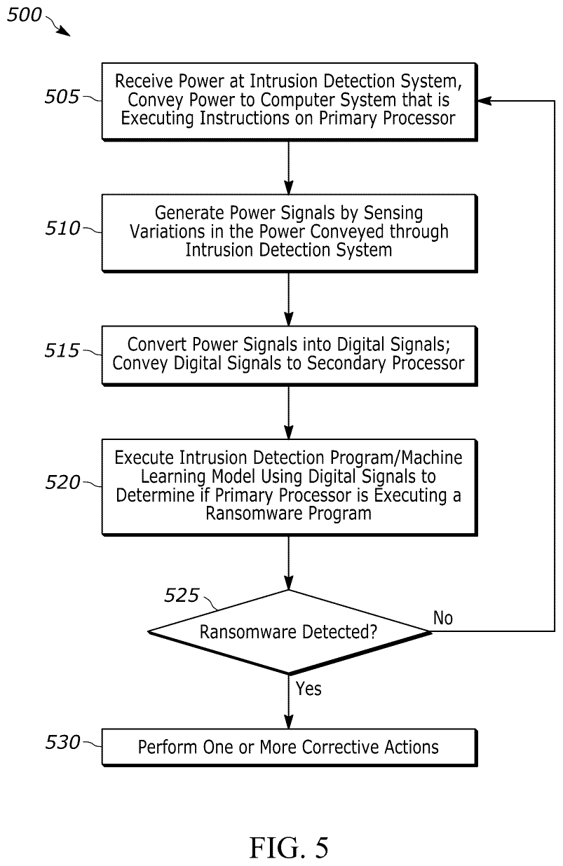

FIG. 5 is a flow diagram illustrating one embodiment for operating an intrusion detection system in accordance with the disclosure. Method 500 may be carried out by various embodiments of an IDPS as discussed above. Embodiments of an IDPS capable of performing Method 500, but not otherwise discussed herein, are considered to fall within the scope of this disclosure.

Method 500 includes receiving power at an IDPS and conveying that power to a computer system executing instructions on its primary processor (block 505). The method further include generating power signals (analog) based on variations in the power conveyed through the IDPS (block 510), and converting these power signals into digital signals that are conveyed to a secondary processor within the IDPS (block 515). The secondary processor in the IDPS may execute an intrusion detection program/machine learning model to determine if the primary processor is executing a ransomware (or more generally, any malware) on the primary processor (block 520). If an intrusion id detected (block 525, yes), one or more corrective actions is performed by the IDPS (block 530). If ransomware/malware is not detected (block 525, no), the method returns to block 505 and continues.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An apparatus for detecting intrusions into a computer system, the apparatus comprising:
a first power interface configured to receive power from an external power source;
a second power interface configured to provide the power to a computer system;
a power bus configured to convey power from the first power interface to the second power interface;
a sensor circuit configured to detect power signals indicative of variations in the power;
an analog-to-digital converter (ADC) circuit configured to, using the power signals, generate a plurality of digital signals;
a storage circuit configured to store a detection program and a machine learning model; and
a processor configured to, using the plurality of digital signals, execute the detection program and the machine learning model, and, in response to detecting an attack on the computer system, perform one or more corrective actions to protect the computer system.

2. The apparatus of claim 1, wherein the sensor circuit comprises an impedance and a voltage measurement circuit configured to detect variations in a voltage across the impedance, wherein the ADC circuit is configured to convert the variations in the voltage across the impedance into the plurality of digital signals.

3. The apparatus of claim 1, wherein the sensor circuit is configured to detect magnetic variations in the power signals and further configured to convert the magnetic variations into voltages, wherein the ADC is configure to convert the voltages into the plurality of digital signals.

4. The apparatus of claim 1, further comprising a network switch, wherein in response to detecting the attack on the computer system, the processor is configured to cause the network switch to disconnect a network interface of the computer system from a router switch.

5. The apparatus of claim 1, further comprising a power switch coupled between the first power interface and the second power interface, wherein in response to detecting the attack on the computer system, the processor is configured to cause the power switch to disconnect power from the computer system.

6. The apparatus of claim 1, wherein in response to detecting the attack on the computer system, the processor is configured to generate an alert to a security operations center.

7. The apparatus of claim 1, wherein the ADC circuit is configured to stream the plurality of digital signals to the processor.

8. The apparatus of claim 1, wherein the processor is configured to, during execution of the machine learning model and using the plurality of digital signals, detect encryption processes associated with a ransomware attack.

9. The apparatus of claim 1, wherein the processor is configured to, during execution of the machine learning model and using the plurality of digital signals, determine an amount and a pattern of input/output traffic of the computer system.

10. The apparatus of claim 1, wherein the processor is configured to perform pre-processing of the plurality of digital signals and further configured, convey, to a remote computer system, pre-processed data for further processing.

11. A method for detecting intrusions into a computer system, the method comprising:
receiving power, in a first power interface of an intrusion detection system, from an external power source;
conveying the power, over a power bus between the first power interface to a second power interface of the intrusion detection system, to a computer system via the second power interface;
detecting, using a sensor circuit coupled to the power bus, power signals indicative of variations in power;
generating, by an analog-to-digital converter (ADC) circuit and using the power signals, a plurality of digital signals;
storing, in a storage circuit of the intrusion detection system, a detection program and a machine learning model;
executing, using a processor of the intrusion detection system, the detection program and the machine learning model; and
performing, by the processor and in response to detecting an attack on the computer system, one or more corrective actions to protect the computer system.

12. The method of claim 11, wherein detecting power signals indicative of variations in power comprises detecting variations in a voltage across an impedance, and wherein the method further comprises streaming the plurality of digital signals to the processor.

13. The method of claim 11, wherein detecting power signals indicative of variations in power comprises detecting magnetic variations corresponding to the variations in power, and wherein the method further comprises generating voltages corresponding to the magnetic variations.

14. The method of claim 11, further comprising disconnecting, using the intrusion detection system, the computer system from a network in response to detecting an attack on the computer system.

15. The method of claim 11, further comprising disconnecting the power from the computer system, using the intrusion detection system, in response to detecting an attack on the computer system.

16. The method of claim 11, further comprising detecting, using the processor and during execution of the detection program and the machine learning model, encryption processes associated with a ransomware attack.

17. The method of claim 11, further comprising determining, using the processor and during execution of the detection program and the machine learning model, an amount and a pattern of input/output traffic of the computer system.

18. A system for detecting intrusions into computer systems, the system comprising:
an intrusion detection system coupled to one or more computer systems, wherein the intrusion detection system includes:
a power bus coupled between a first power interface and a second power interface, wherein the intrusion detection system is configured to receive power from an external power source via the first power interface and convey power to the one or more computer systems via the second power interface;
a sensor circuit coupled to the power bus and configured to detect power signals indicative of variations in the power;
an analog-to-digital converter (ADC) circuit configured to convert the power signals into a plurality of digital signals;
a storage circuit configured to store a detection program a machine learning model; and
a processor configured to, using the plurality of digital signals, execute the detection program and the machine learning model, and, in response to detecting an attack on a given one of the one or more computer systems, perform one or more corrective actions to protect the given one of the one or more computer systems.

19. The system of claim 18, wherein the sensor circuit comprises an impedance and a voltage measurement circuit configured to detect variations in a voltage across the impedance, wherein the ADC circuit is configured to convert the variations in the voltage across the impedance into the plurality of digital signals and further configured to stream the plurality of digital signals to the processor, and wherein the processor is configured to, using the detection program and the machine learning model, detect a signature of an attack in the plurality of digital signals.

20. The system of claim 18, wherein, in response to detecting an attack on the given one of the one or more computer systems, the processor is configured to cause the intrusion detection system to perform one or more of the following:
disconnecting power to the given one of the one or more computer systems;
disconnecting the given one of the one or more computer systems from a network; and
generating an alert to a security operations center.
